(19) United States
(12) Patent Application Publication
(10) Pub. No.: US 2024/0013756 A1
(43) Pub. Date: Jan. 11, 2024

(54) INFORMATION PROCESSING METHOD, INFORMATION PROCESSING SYSTEM, AND NON-TRANSITORY COMPUTER-READABLE MEDIUM

(71) Applicant: YAMAHA CORPORATION, Hamamatsu-shi (JP)

(72) Inventor: Akira MAEZAWA, Hamamatsu-shi (JP)

(21) Appl. No.: 18/472,432

(22) Filed: Sep. 22, 2023

Related U.S. Application Data
(63) Continuation of application No. PCT/JP2022/009831, filed on Mar. 7, 2022.

(30) Foreign Application Priority Data
Mar. 25, 2021 (JP) 2021-051182

(51) Int. Cl. G10H 1/00; G10H 1/34

(52) U.S. Cl. CPC G10H 1/0008; G10H 1/34; G10H 2220/455

(57) ABSTRACT

An information processing method is implemented by a computer system. The information processing method includes: generating operation data representing one or more fingers, of a plurality of fingers of a left hand and a right hand of a user, that operate a musical instrument, by analyzing a performance image indicating the plurality of fingers of the user who plays the musical instrument; and executing first processing in a case where the operation data represents the musical instrument being operated with a finger of the left hand, and executing second processing different from the first processing in a case where the operation data represents the musical instrument being operated with a finger of the right hand.

### CROSS-REFERENCE TO RELATED APPLICATIONS

This is a continuation of International Application No. PCT/JP2022/009831 filed on Mar. 7, 2022, and claims priority from Japanese Patent Application No. 2021-051182 filed on Mar. 25, 2021, the entire content of which is incorporated herein by reference.

### TECHNICAL FIELD

The present disclosure relates to a technique for analyzing performance by a user.

### BACKGROUND ART

In related art, there are various techniques for controlling operation of various electronic musical instruments. For example, JP3346143B2 discloses a technique of setting a split point at a random position of performance operators, and reproducing tones having characteristics which are different between when one of areas sandwiching the split point is operated and when the other of the areas is operated.

### SUMMARY

Incidentally, for example, if tones are reproduced to have characteristics which are different between when a user plays a musical instrument with a right hand and when the user plays the musical instrument with a left hand, it is possible to achieve diverse performance such as performing a right hand part and a left hand part of a musical composition with, for example, different timbres. However, when focusing on, for example, playing a keyboard instrument, it is difficult to set a split point between a range played by the right hand and a range played by the left hand with high accuracy, especially, when the right hand and the left hand are close to each other or overlap each other, or when a right arm and a left arm are crossed (the right hand and the left hand are reversed in a left-right direction).

In the above description, it is assumed that tones are generated to have characteristics which are different between operation with the right hand and operation with the left hand, but the same problem is assumed in any scene where different processing is executed depending on operation with the right hand and operation with the left hand. In consideration of the above circumstance, an object of one aspect of the present disclosure is to clearly distinguish between processing in response to operation with the right hand and processing in response to operation with the left hand.

The present disclosure provides an information processing method implemented by a computer system, the information processing method including: generating operation data representing one or more fingers, of a plurality of fingers of a left hand and a right hand of a user, that operate a musical instrument, by analyzing a performance image indicating the plurality of fingers of the user who plays the musical instrument; and executing first processing in a case where the operation data represents the musical instrument being operated with a finger of the left hand, and executing second processing different from the first processing in a case where the operation data represents the musical instrument being operated with a finger of the right hand.

The present disclosure provides an information processing system including: a memory configured to store instructions; and a processor communicatively connected to the memory and configured to execute the stored instructions to function as: a performance analysis unit configured to generate operation data representing one or more fingers, of a plurality of fingers of a left hand and a right hand of a user, that operate a musical instrument, by analyzing a performance image indicating the plurality of fingers of the user who plays the musical instrument; and an operation control unit configured to execute first processing in a case where the operation data represents the musical instrument being operated with a finger of the left hand, and execute second processing different from the first processing in a case where the operation data represents the musical instrument being operated with a finger of the right hand.

The present disclosure provides a non-transitory computer-readable medium storing a program that causes a computer system to function as: a performance analysis unit configured to generate operation data representing one or more fingers, of a plurality of fingers of a left hand and a right hand of a user, that operate a musical instrument, by analyzing a performance image indicating the plurality of fingers of the user who plays the musical instrument; and an operation control unit configured to execute first processing in a case where the operation data represents the musical instrument being operated with a finger of the left hand, and execute second processing different from the first processing in a case where the operation data represents the musical instrument being operated with a finger of the right hand.

### BRIEF DESCRIPTION OF DRAWINGS

The present disclosure will be described in detail based on the following figures, wherein:

FIG. 1 is a block diagram illustrating a configuration of an electronic musical instrument according to a first embodiment;

FIG. 2 is a schematic diagram of a performance image;

FIG. 3 is a block diagram illustrating a functional configuration of an information processing system;

FIG. 4 is a schematic diagram of an analysis screen;

FIG. 5 is a flowchart of operation control processing;

FIG. 6 is a flowchart of finger position estimation processing;

FIG. 7 is a flowchart of left-right determination processing;

FIG. 8 is an explanatory diagram of image extraction processing;

FIG. 9 is a flowchart of the image extraction processing;

FIG. 10 is an explanatory diagram of machine learning for establishing an estimation model;

FIG. 11 is a schematic diagram of a reference image;

FIG. 12 is a flowchart of matrix generation processing;

FIG. 13 is a flowchart of initialization processing;

FIG. 14 is a schematic diagram of a setting screen;

FIG. 15 is a flowchart of performance analysis processing;

FIG. 16 is an explanatory diagram relating to a response characteristic;

FIG. 17 is an explanatory diagram related to a technical problem of fingering estimation;

FIG. 18 is a block diagram illustrating a configuration of an information processing system according to a third embodiment;

FIG. 19 is a schematic diagram of control data in the third embodiment;

FIG. 20 is a flowchart of performance analysis processing in the third embodiment;

FIG. 21 is a flowchart of performance analysis processing in a fourth embodiment; and

FIG. 22 is a flowchart of initialization processing in a fifth embodiment.

### DESCRIPTION OF EMBODIMENTS

### 1: First Embodiment

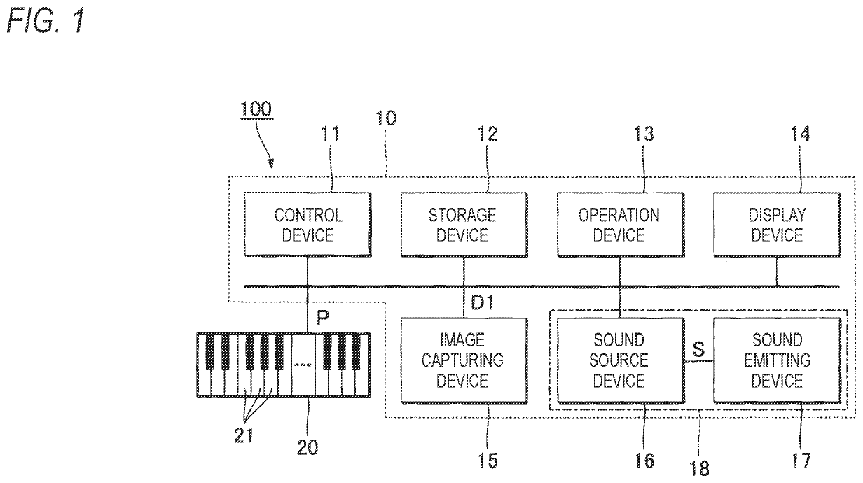

FIG. 1 is a block diagram illustrating a configuration of an electronic musical instrument 100 according to the first embodiment. The electronic musical instrument 100 is a keyboard instrument that includes an information processing system 10 and a keyboard unit 20. The information processing system 10 and the keyboard unit 20 are stored in a housing of the electronic musical instrument 100. However, another embodiment in which the information processing system 10 is connected by wire or wirelessly to the electronic musical instrument 100 including the keyboard unit 20 may be assumed.

The keyboard unit 20 is a performance device in which a plurality of keys 21 (the number of keys is N) are arranged. The plurality of keys 21 of the keyboard unit 20 correspond to different pitches n (n=1 to N). A user (that is, a performer) sequentially operates desired keys 21 of the keyboard unit 20 with his or her left hand and right hand. The keyboard unit 20 generates performance data P representing the performance by the user. The performance data P is time-series data that specifies a pitch n of each key 21 for each operation on the key 21 by the user. For example, the performance data P is data in a format conforming to the Musical Instrument Digital Interface (MIDI) standard.

The information processing system 10 is a computer system that analyzes the performance of the keyboard unit 20 by the user. Specifically, the information processing system 10 includes a control device 11, a storage device 12, an operation device 13, a display device 14, an image capturing device 15, a sound source device 16, and a sound emitting device 17. The information processing system 10 may be implemented as a single device, or may be implemented as a plurality of devices configured separately from each other.

The control device 11 includes one or more processors that control each element of the information processing system 10. For example, the control device 11 is implemented by one or more types of processors such as a central processing unit (CPU), a sound processing unit (SPU), a digital signal processor (DSP), a field programmable gate array (FPGA), an application specific integrated circuit (ASIC), etc.

The storage device 12 includes one or more memories that store programs executed by the control device 11 and various types of data used by the control device 11. The storage device 12 may be implemented by a known recording medium such as a magnetic recording medium or a semiconductor recording medium, or a combination of a plurality of types of recording media. As the storage device 12, portable recording medium that can be attached to and detached from the information processing system 10, or a recording medium (for example, a cloud storage) that can be written or read by the control device 11 via a communication network such as the Internet may be used.

The operation device 13 is an input device that receives an instruction from the user. The operation device 13 includes, for example, an operator operated by the user or a touch panel that detects contact by the user. The operation device 13 (for example, a mouse or a keyboard), which is separated from the information processing system 10, may be connected to the information processing system 10 by wire or wirelessly.

The display device 14 displays images under control of the control device 11. For example, various display panels such as a liquid crystal display panel or an organic EL (Electroluminescence) panel are used as the display device 14. The display device 14, which is separated from the information processing system 10, may be connected to the information processing system 10 by wire or wirelessly.

The image capturing device 15 is an image input device that generates a time series of image data D1 by capturing an image of the keyboard unit 20. The time series of the image data D1 is moving image data representing moving images. For example, the image capturing device 15 includes an optical system such as an imaging lens, an imaging element for receiving incident light from the optical system, and a processing circuit for generating the image data D1 in accordance with an amount of light received by the imaging element. The image capturing device 15, which is separated from the information processing system 10, may be connected to the information processing system 10 by wire or wirelessly.

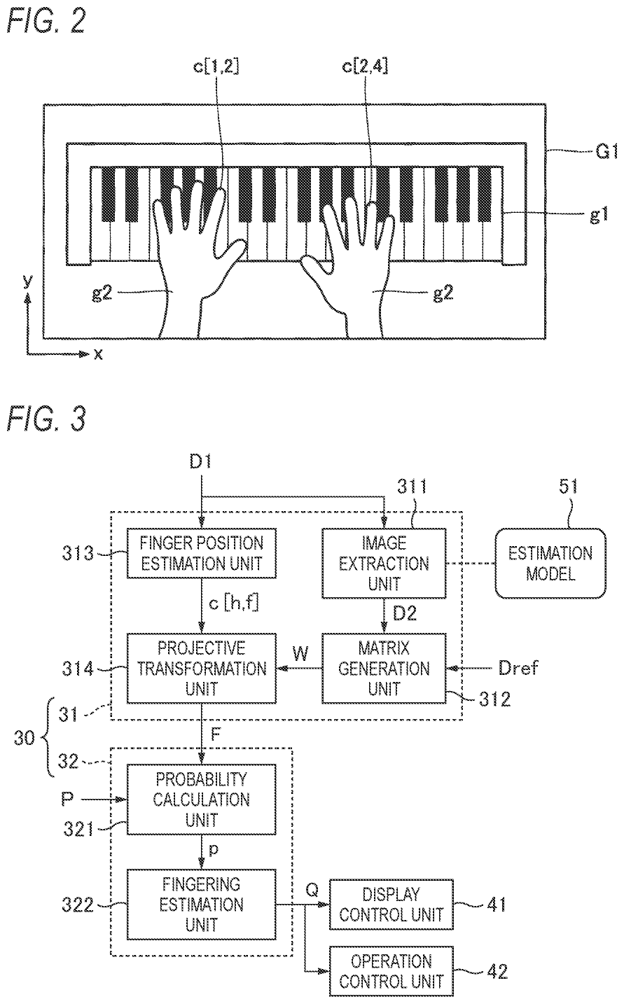

The user adjusts a position or an angle of the image capturing device 15 with respect to the keyboard unit 20 so that an image capturing condition recommended by a provider of the information processing system 10 is achieved. Specifically, the image capturing device 15 is disposed above the keyboard unit 20 and captures images of the keyboard unit 20 and the left hand and the right hand of the user. Therefore, as illustrated in FIG. 2, the time series of the image data D1 representing a performance image G1 is generated by the image capturing device 15. The performance image G1 includes an image g1 of the keyboard unit 20 and an image g2 of the left hand and the right hand of the user. As used herein, the image g1 may also be referred to as a “keyboard image” and the image g2 may also be referred to as a “finger image”. That is, the moving image data representing the moving images of the user playing the keyboard unit 20 is generated in parallel with the performance. The image capturing condition by the image capturing device 15 is, for example, an image capturing range or an image capturing direction. The image capturing range is a range (angle of view) of an image to be captured by the image capturing device 15. The image capturing direction is a direction in which the image capturing device 15 is oriented with respect to the keyboard unit 20.

The sound source device 16 generates a sound signal S in accordance with operation on the keyboard unit 20. The sound signal S is a sample sequence representing a waveform of sounds instructed by the performance on the keyboard unit 20. Specifically, the sound source device 16 generates the sound signal S representing a sound of the pitch n corresponding to the key 21 operated by the user among the plurality of keys 21 of the keyboard unit 20. The control device 11 may implement the function of the sound source device 16 by executing a program stored in the storage device 12. In this case, the sound source device 16 dedicated to generating the sound signal S may be omitted.

The sound source device 16 of the first embodiment can generate the sound signal S representing a sound of any one timbre of a plurality of types of timbres. Specifically, the sound source device 16 generates the sound signal S representing a sound of either a first timbre or a second timbre. The first timbre and the second timbre are different timbres. Although the combination of the first timbre and the second timbre may be freely selected, the following combinations are exemplified for example.

The first timbre and the second timbre are timbres corresponding to different types of musical instruments. For example, the first timbre is a timbre of a keyboard instrument (for example, the plano), and the second timbre is a timbre of a string instrument (for example, the violin). The first timbre and the second timbre may be timbres of different musical instruments with a common classification in accordance with types of sound sources thereof. For example, in the case of wind instruments, the first timbre is a timbre of the trumpet, and the second timbre is a timbre of the horn. The first timbre and the second timbre may also be timbres of sounds produced by different rendition styles of musical instruments of the same type. For example, in the case of the violin, the first timbre is a timbre of a sound produced by bowing (Arco), and the second timbre is a timbre of a sound produced by plucking (Pizzicato). One or both of the first timbre and the second timbre may be timbres of singing voices. For example, the first timbre is a male voice and the second timbre is a female voice. Each of the first timbre and the second timbre is freely set in accordance with an instruction from the user to the operation device 13.

The sound emitting device 17 emits a sound represented by the sound signal S. The sound emitting device 17 is, for example, a speaker or headphones. As can be understood from the above description, the sound source device 16 and the sound emitting device 17 function as a reproduction system 18 that reproduces sounds in accordance with performance by the user on the keyboard unit 20.

FIG. 3 is a block diagram illustrating a functional configuration of the information processing system 10. The control device 11 implements a performance analysis unit 30, a display control unit 41 and an operation control unit 42 by executing programs stored in the storage device 12.

The performance analysis unit 30 generates operation data Q by analyzing the performance data P and image data D1. The operation data Q is data that specifies with which of the plurality of fingers of the left hand or the right hand of the user each key 21 of the keyboard unit 20 is operated (that is, fingering). Specifically, the operation data Q specifies the pitch n corresponding to the key 21 operated by the user and the number k of the finger used by the user to operate the key 21. As used herein, the number k of the finger may be referred to as a “finger number”. The pitch n is, for example, a note number in the MIDI standard. The finger number k is a number assigned to each finger of the left hand and the right hand of the user. Different finger numbers k are assigned to the fingers of the left hand and the fingers of the right hand. Therefore, by referring to the finger number k, it is possible to determine whether the finger specified by the operation data Q is a finger of the left hand or of the right hand.

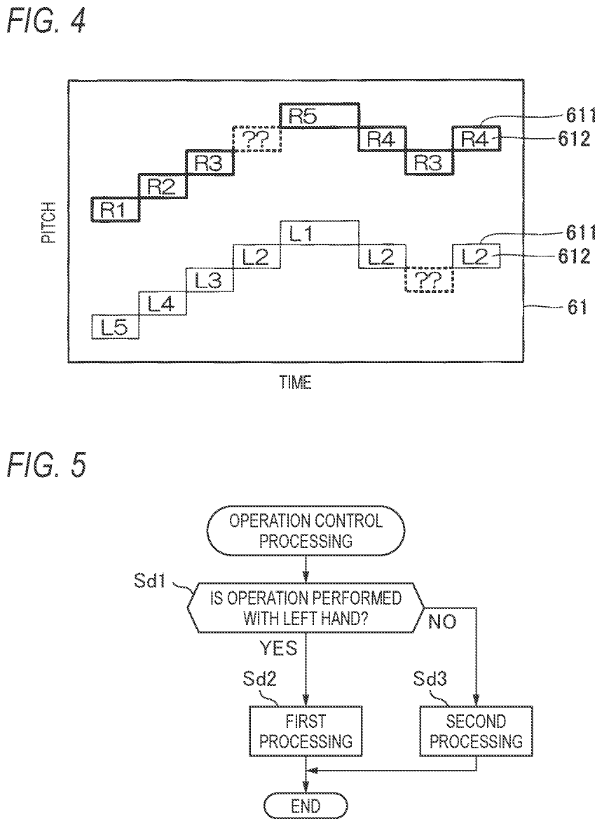

The display control unit 41 causes the display device 14 to display various images. For example, the display control unit 41 causes the display device 14 to display an image 61 indicating a result of analysis by the performance analysis unit 30. As used herein, the image 61 may also be referred to as an “analysis screen”. FIG. 4 is a schematic diagram of the analysis screen 61. The analysis screen 61 is an image in which a plurality of note images 611 are arranged on a coordinate plane on which a horizontal time axis and a vertical pitch axis are set. The note image 611 is displayed for each note played by the user. A position of the note image 611 in the pitch axis direction is set in accordance with the pitch n of the note represented by the note image 611. A position and a total length of the note image 611 in the time axis direction are set in accordance with a sounding period of the note represented by the note image 611.

In the note image 611 of each note, a code 612 corresponding to the finger number k specified for the note by the operation data Q is arranged. As used herein the code 612 may also be referred to as a “fingering code”. The letter “L” in the fingering code 612 means the left hand, and the letter “R” in the fingering code 612 means the right hand. The number in the fingering code 612 means a corresponding finger. Specifically, a number “1” in the fingering code 612 means the thumb, and a number “2” means the index finger, and a number “3” means the middle finger, and a number “4” means the ring finger, and the number “5” means the little finger. Therefore, for example, the fingering code 612 “R2” refers to the index finger of the right hand and the fingering code 612 “L4” refers to the ring finger of the left hand. The note image 611 and the fingering code 612 are displayed in different modes (for example, different hues or different gradations) for the right hand and the left hand. The display control unit 41 causes the display device 14 to display the analysis screen 61 of FIG. 4 using the operation data Q.

Among the plurality of note images 611 in the analysis screen 61, the note image 611 of a note with low reliability in an estimation result of the finger number k is displayed in a manner (for example, a dashed frame line) different from a normal note image 611, and a specific code, such as “??”, is displayed to indicate that the estimation result of the finger number k is invalid.

The operation control unit 42 in FIG. 3 executes processing in accordance with the operation data Q. The operation control unit 42 of the first embodiment selectively executes either first processing or second processing in accordance with the operation data Q. Specifically, the operation control unit 42 executes the first processing when the operation data Q represents the keyboard unit 20 being operated with the finger of the left hand, and executes the second processing when the operation data Q represents the keyboard unit 20 being operated with the finger of the right hand. As exemplified below, the first processing is different from the second processing.

The first processing is processing of reproducing the sound of the first timbre. Specifically, the operation control unit 42 sends to the sound source device 16 a sound generation instruction including designation of the pitch n specified by the operation data Q and the first timbre. The sound source device 16 generates the sound signal S representing the first timbre and the pitch n in response to the sound generation instruction from the operation control unit 42. By supplying the sound signal S to the sound emitting device 17, the sound emitting device 17 reproduces the sound of the first timbre and the pitch n. That is, the first processing is processing of causing the reproduction system 18 to reproduce a sound of the first timbre.

The second processing is processing of reproducing the sound of the second timbre. Specifically, the operation control unit 42 sends, to the sound source device 16, a sound generation instruction including designation of the pitch n specified by the operation data Q and the second timbre. The sound source device 16 generates the sound signal S representing the second timbre and the pitch n in response to the sound generation instruction from the operation control unit 42. By supplying the sound signal S to the sound emitting device 17, the sound emitting device 17 reproduces the sound of the second timbre and the pitch n. That is, the second processing is processing of causing the reproduction system 18 to reproduce a sound of the second timbre.

As can be understood from the above description, the sound of the pitch n corresponding to the key 21 operated by the user with the left hand is reproduced in the first timbre, and the sound of the pitch n corresponding to the key 21 operated by the user with the right hand is reproduced in the second timbre. That is, even when the user operates the key 21 corresponding to a specific pitch n, the timbre of the sound of the pitch n reproduced by the reproduction system 18 differs depending on whether the user operates the key 21 with the left hand or the right hand.

FIG. 5 is a flowchart illustrating a specific procedure of processing executed by the operation control unit 42. As used herein, the processing may be referred to as “operation control processing”. When the operation control processing is started, the operation control unit 42 determines whether the finger number k specified by the operation data Q is a number corresponding to the left hand (Sd1). That is, it is determined whether the user operates the keyboard unit 20 with the finger of the left hand. If the finger number k corresponds to the left hand (Sd1: YES), the operation control unit 42 executes the first processing (Sd2). That is, the operation control unit 42 causes the reproduction system 18 to reproduce the sound of the pitch n specified by the operation data Q in the first timbre. On the other hand, if the finger number k corresponds to the right hand (Sd1: NO), the operation control unit 42 executes the second processing (Sd3). That is, the operation control unit 42 causes the reproduction system 18 to reproduce the sound of the pitch n specified by the operation data Q in the second timbre.

As described above, in the first embodiment, the operation data Q is generated by analyzing the performance image G1, and different processing is executed depending on whether the operation data Q represents an operation with the finger of the left hand or the finger of the right hand. Therefore, for example, even when the user plays with the left hand and the right hand close to each other or overlapping each other, or with a right arm and a left arm crossed (reversed in a left-right direction), a clear distinguishing can be made between the first processing corresponding to the operation with the left hand and the second processing corresponding to the operation with the right hand.

Especially in the first embodiment, sounds with different timbres are reproduced depending on whether the operation data Q represents an operation with the finger of the left hand or the finger of the right hand. Therefore, it is possible to achieve diverse performance in which sounds with different timbres are reproduced by the operation with the left hand and the operation with the right hand.

Hereinafter, the specific configuration of the performance analysis unit 30 will be described. As illustrated in FIG. 3, the performance analysis unit 30 includes a finger position data generation unit 31 and an operation data generation unit 32. The finger position data generation unit 31 generates the finger position data F by analyzing the performance image G1. The finger position data F is data representing the position of each finger of the left hand and the position of each finger of the right hand of the user. As described above, in the first embodiment, since the position of each finger of the user is distinguished between the left hand and the right hand, it is possible to estimate the fingering that distinguishes between the left hand and the right hand of the user. On the other hand, the operation data generation unit 32 generates the operation data Q using the performance data P and the finger position data F. The finger position data F and the operation data Q are generated for each unit period on the time axis. Each unit period is a period (frame) of a predetermined length.

A: Finger Position Data Generation Unit 31

The finger position data generation unit 31 includes an image extraction unit 311, a matrix generation unit 312, a finger position estimation unit 313 and a projective transformation unit 314.

Finger Position Estimation Unit 313

The finger position estimation unit 313 estimates the position c[h, f] of each finger of the left hand and the right hand of the user by analyzing the performance image G1 represented by the image data D1. The position c[h, f] of each finger is a position of each fingertip in an x-y coordinate system set in the performance image G1. The position c[h, f] is expressed by a combination (x[h, f], y[h, f]) of a coordinate x[h, f] on an x-axis and a coordinate on a y-axis y[h, f] in the x-y coordinate system of the performance image G1. A positive direction of the x-axis corresponds to a right direction of the keyboard unit 20 (a direction from low tones to high tones), and a negative direction of the x-axis corresponds to a left direction of the keyboard unit 20 (a direction from high tones to low tones). The symbol h is a variable indicating either the left hand or the right hand (h=1, 2). Specifically, the numerical value “1” of the variable h means the left hand, and the numerical value “2” of the variable h means the right hand. The variable f is the number of each finger in each of the left hand and the right hand (f=1 to 5). The number “1” of the variable f means the thumb, and the number “2” means the index finger, and the number “3” means the middle finger, and the number “4” means the ring finger, and the number “5” means the little finger. Therefore, for example, a position c[1, 2] illustrated in FIG. 2 is a position of the fingertip of the index finger (f=2) of the left hand (h=1), and a position c[2, 4] is a position of the fingertip of the ring finger (f=4) of the right hand (h=2).

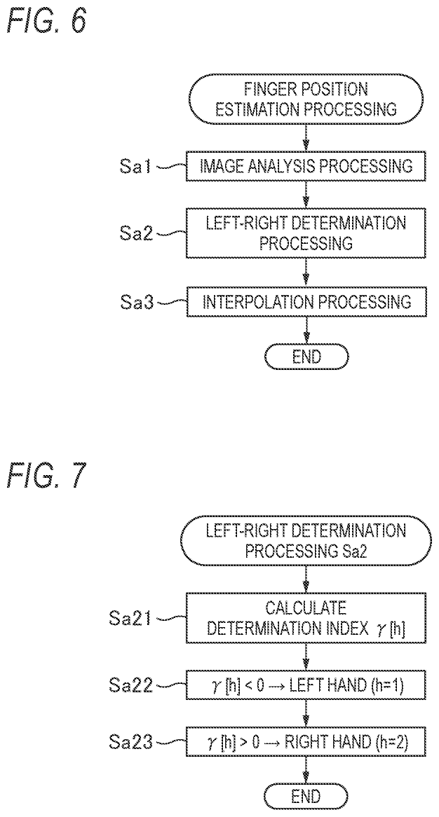

FIG. 6 is a flowchart illustrating a specific procedure of processing of estimating the position of each finger of the user by the finger position estimation unit 313. As used herein, the processing may also be referred to as “finger position estimation processing”. The finger position estimation processing includes image analysis processing Sa1, left-right determination processing Sa2, and interpolation processing Sa3.

The image analysis processing Sa1 is processing of estimating the position c[h, f] of each finger on one of the left hand and the right hand of the user and the position c[h, f] of each finger on the other of the left hand and the right hand of the user by analyzing the performance image G1. As used herein, the one of the left hand and the right hand may also be referred to as a “first hand” and the other thereof may also be referred to as a “second hand”. Specifically, the finger position estimation unit 313 estimates the position c[h, 1] to c[h, 5] of each finger of the first hand and the position c[h, 1] to c[h, 5] of each finger of the second hand through image recognition processing of estimating a skeleton or joints of the user through image analysis. For the image analysis processing Sa1, known image recognition processing such as the MediaPipe or the OpenPose may be used. When no fingertip is detected from the performance image G1, the coordinate x[h, f] of the fingertip on the x-axis is set to an invalid value such as “0”.

In the image analysis processing Sa1, the positions c[h, 1] to c[h, 5] of the fingers of the first hand and the positions c[h, 1] to c[h, 5] of the fingers of the second hand of the user are estimated, but it is not possible to specify whether the first hand or the second hand corresponds to the left hand or the right hand of the user. Since in the performance of the keyboard unit 20, a right arm and a left arm of the user may cross, it is not appropriate to determine the left hand or the right hand from only the coordinate x[h, f] of each position c[h, f] estimated by the image analysis processing Sa1. If an image of a portion including arms and body of the user is captured by the image capturing device 15, the left hand or the right hand of the user can be estimated from the performance image G1 based on coordinates of shoulders and arms of the user. However, there may be a problem that it is necessary to capture an image with a wide range by the image capturing device 15, and a problem that processing load of the image analysis processing Sa1 increases.

In consideration of the above circumstances, the finger position estimation unit 313 of the first embodiment executes the left-right determination processing Sa2 shown in FIG. 6 of determining whether the first hand or the second hand corresponds to the left hand or the right hand of the user. That is, the finger position estimation unit 313 determines the variable h in each finger position c[h, f] of the first hand and the second hand to be either the numerical value “1” representing the left hand or the numerical value “2” representing the right hand. When the keyboard unit 20 is played, backs of both the left hand and the right

hand are positioned vertically upward, so that the performance image G1 captured by the image capturing device 15 is an image of the backs of both the left hand and the right hand of the user. Therefore, in the left hand in the performance image G1, the thumb position c[h, 1] is positioned on the right side of the little finger position c[h, 5], and in the right hand in the performance image G1, the thumb position c[h, 1] is positioned on the left side of the little finger position c[h, 5]. Considering the above circumstances, in the left-right determination processing Sa2, the finger position estimation unit 313 determines that of the first hand and the second hand, the hand in which the thumb position c[h, 1] is positioned on the right side (in the positive direction of the x-axis) of the little finger position c[h, 5] is the left hand (h=1). On the other hand, the finger position estimation unit 313 determines that of the first hand and the second hand, the hand in which the thumb position c[h, 1] is positioned on the left side (in the negative direction of the x-axis) of the little finger position c[h, 5] is the right hand.

FIG. 7 is a flowchart illustrating a specific procedure of the left-right determination processing Sa2. The finger position estimation unit 313 calculates a determination index γ[h] for each of the first hand and the second hand (Sa21). The determination index γ[h] is calculated by, for example, Equation (1) below.

γ[h]=Σ_{f=1}⁵f(x[h,f]−μ[h]) (1)

The symbol μ[h] in Equation (1) is a mean value (for example, simple mean) of the coordinates x[h, 1] to x[h, 5] of the five fingers of each of the first hand and the second hand. As can be understood from Equation (1), when the coordinate x[h, f] decreases from the thumb to the little finger (left hand), the determination index γ[h] is a negative number, and when the coordinate x[h, f] increases from the thumb to the little finger (right hand), the determination index γ[h] is a positive number. Therefore, the finger position estimation unit 313 determines that the hand, of the first hand and the second hand, having a negative determination index γ[h] is the left hand, and sets the variable h to the numerical value “1” (Sa22). The finger position estimation unit 313 determines that the hand, of the first hand and the second hand, having a positive determination index γ[h] is the right hand, and sets the variable h to the numerical value “2” (Sa23). According to the left-right determination processing Sa2 described above, the position c[h, f] of each finger of the user can be distinguished between the right hand and the left hand by simple processing using a relation between the position of the thumb and the position of the little finger.

The position c[h, f] of each finger of the user is estimated for each unit period by the image analysis processing Sa1 and the left-right determination processing Sa2. However, the position c[h, f] may not be properly estimated due to various circumstances such as noise existing in the performance image G1. Therefore, when the position c[h, f] is missing in a specific unit period (hereinafter referred to as “missing period”), the finger position estimation unit 313 calculates the position c[h, f] in the missing period by the interpolation processing Sa3 using the positions c[h, f] in the unit periods before and after the missing period. For example, when the position c[h, f] is missing in a central unit period (missing period) among three consecutive unit periods on the time axis, a mean of the position c[h, f] in the unit period immediately before the missing period and the position c[h, f] in the unit period immediately after that is calculated as the position in the missing period.

Image Extraction Unit 311

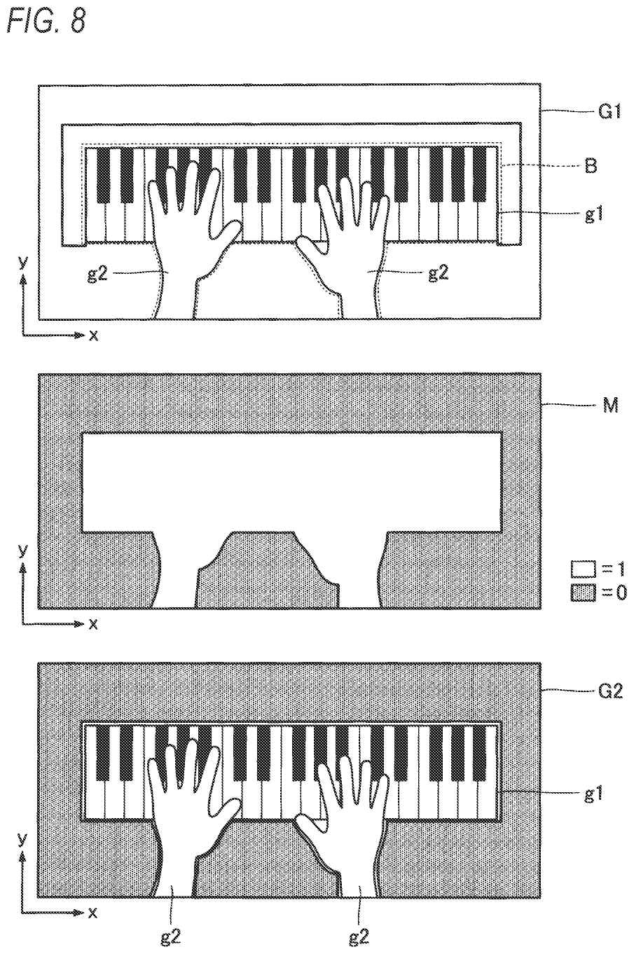

As described above, the performance image G1 includes the keyboard image g1 and the finger image g2. The image extraction unit 311 shown in FIG. 3 extracts a specific area B from the performance image G1, as illustrated in FIG. 8. The specific area B is an area of the performance image G1 that includes the keyboard image g1 and the finger image g2. The finger image g2 corresponds to an image of at least a part of the body of the user.

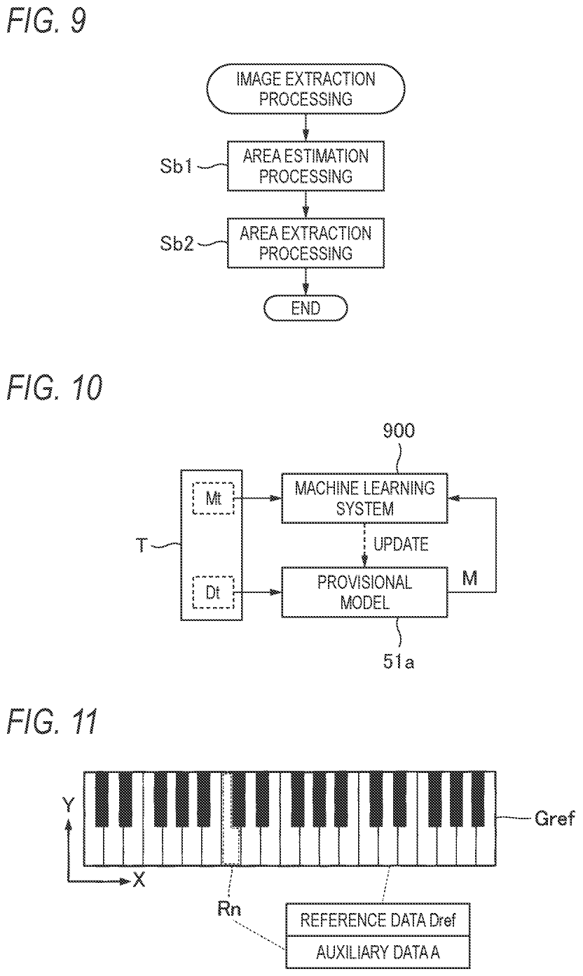

FIG. 9 is a flowchart illustrating a specific procedure of processing of the image extraction unit 311 extracting the specific area B from the performance image G1. As used herein, the processing may also be referred to as “image extraction processing”. The image extraction processing includes area estimation processing Sb1 and area extraction processing Sb2.

The area estimation processing Sb1 is processing of estimating the specific area B for the performance image G1 represented by the image data D1. Specifically, the image extraction unit 311 generates an image processing mask M indicating the specific area B from the image data D1 by the area estimation processing Sb1. As illustrated in FIG. 8, the image processing mask M is a mask having the same size as the performance image G1, and includes a plurality of elements corresponding to different pixels of the performance image G1. Specifically, the image processing mask M is a binary mask in which each element in an area corresponding to the specific area B of the performance image G1 is set to the numerical value “1”, and each element in an area other than the specific area B is set to the numerical value “0”. An element (area estimation unit) for estimating the specific area B of the performance image G1 is implemented by the control device 11 executing the area estimation processing Sb1.

As illustrated in FIG. 3, an estimation model 51 is used for generating the image processing mask M by the image extraction unit 311. That is, the image extraction unit 311 generates the image processing mask M by inputting the image data D1 representing the performance image G1 to the estimation model 51. The estimation model 51 is a statistical model obtained by machine-learning a relation between the image data D1 and the image processing mask M. The estimation model 51 is implemented by, for example, a deep neural network (DNN). For example, any form of deep neural network such as a convolutional neural network (CNN) or a recurrent neural network (RNN) is used as the estimation model 51. The estimation model 51 may be configured by combining multiple types of deep neural networks. Additional elements such as long short-term memory (LSTM) may also be included in the estimation model 51.

FIG. 10 is an explanatory diagram of machine learning for establishing the estimation model 51. For example, the estimation model 51 is established by machine learning by a machine learning system 900 separated from the information processing system 10, and the estimation model 51 is provided to the information processing system 10. The machine learning system 900 is a server system capable of communicating with information processing system 10 via a communication network such as the Internet. The estimation model 51 is transmitted from the machine learning system 900 to the information processing system 10 via the communication network.

A plurality of pieces of learning data T is used for the machine learning of the estimation model 51. Each of the plurality of pieces of learning data T is a combination of image data Dt for learning and image processing mask Mt for learning. The image data Dt represents an already-captured image including the keyboard image g1 of the keyboard instrument and an image around the keyboard instrument. A model of the keyboard instrument and the image capturing condition (for example, the image capturing range or the image capturing direction) differ for each piece of image data Dt. That is, the image data Dt is prepared in advance by capturing an image of each of a plurality of types of keyboard instruments under different image capturing conditions. The image data Dt may be prepared by a known image synthesizing technique. The image processing mask Mt of each piece of learning data T is a mask indicating the specific area B in the already-captured image represented by the image data Dt of the learning data T. Specifically, elements in an area corresponding to the specific area B in the image processing mask Mt are set to the numerical value “1”, and elements in an area other than the specific area B are set to the numerical value “0”. That is, the image processing mask Mt means a correct answer that the estimation model 51 is to output in response to input of the image data Dt.

The machine learning system 900 calculates an error function representing an error between the image processing mask M output by an initial or provisional model 51a in response to input of the image data Dt of each piece of learning data T and the image processing mask M of the learning data T. As used herein the model 51a may also be referred to as a “provisional model”. The machine learning system 900 then updates a plurality of variables of the provisional model 51a so that the error function is reduced. The provisional model 51a after the above processing is repeated for each of the plurality pieces of learning data T is determined as the estimation model 51. Therefore, the estimation model 51 can output a statistically valid image processing mask M for an image data D1 to be captured in the future under a latent relation between the image data Dt and the image processing mask Mt in the plurality of pieces of learning data T. That is, the estimation model 51 is a trained model that learns the relation between the image data Dt and the image processing mask Mt.

As described above, in the first embodiment, the image processing mask M indicating the specific area B is generated by inputting the image data D1 of the performance image G1 into the machine-learned estimation model 51. Therefore, the specific area B can be specified with high accuracy for various performance images G1 to be captured in the future.

The area extraction processing Sb2 shown in FIG. 9 is processing of extracting the specific area B from the performance image G1 represented by the image data D1. Specifically, the area extraction processing Sb2 is image processing of emphasizing the specific area B by selectively removing areas other than the specific area in the performance image G1. The image extraction unit 311 of the first embodiment generates image data D2 by applying the image processing mask M to the image data D1 (performance image G1). Specifically, the image extraction unit 311 multiplies a pixel value of each pixel in the performance image G1 by an element corresponding to the pixel of the image processing mask M. As illustrated in FIG. 8, the area extraction processing Sb2 generates the image data D2 representing an image obtained by removing areas other than the specific area B from the performance image G1. As used herein, the obtained image may also be referred to as a “performance image G2”. That is, the performance image G2 represented by the image data D2 is an image obtained by extracting the keyboard image g1 and the finger image g2 from the performance image G1. An element (area extraction unit) for extracting the specific area B of the performance image G1 is implemented by the control device 11 executing the area extraction processing Sb2.

Projective Transformation Unit 314

The position c[h, f] of each finger estimated by the finger position estimation processing is a coordinate in the x-y coordinate system set in the performance image G1. The image capturing condition for the keyboard unit 20 by the image capturing device 15 may differ depending on various circumstances such as usage environment of the keyboard unit 20. For example, compared with the ideal image capturing condition illustrated in FIG. 2, it is assumed that the image capturing range may be too wide (or too narrow), or that the image capturing direction may be inclined with respect to the vertical direction. The numerical values of the coordinate x[h, f] and the coordinate γ[h, f] of each position c[h, f] depend on the image capturing condition of the performance image G1 by the image capturing device 15. Therefore, the projective transformation unit 314 of the first embodiment transforms (performs image registration) the position c[h, f] of each finger in the performance image G1 to a position C[h, f] in an X-Y coordinate system that does not substantially depend on the image capturing condition by the image capturing device 15. The finger position data F generated by the finger position data generation unit 31 is data representing the position C[h, f] after transformation by the projective transformation unit 314. That is, the finger position data F specifies the positions C[1, 1] to C[1, 5] of the fingers of the left hand of the user and the positions C[2, 1] to C[2, 5] of the fingers of the right hand of the user.

The X-Y coordinate system is set in a predetermined image Gref, as illustrated in FIG. 11. As used herein the image Gref may also be referred to as a “reference image”. The reference image Gref is an image of a keyboard of a standard keyboard instrument (hereinafter referred to as “reference instrument”) captured under a standard image capturing condition. The reference image Gref is not limited to an image of an actual keyboard. For example, as the reference image Gref, an image synthesized by a known image synthesis technique may be used. In the storage device 12, image data Dref representing the reference image Gref and auxiliary data A relating to the reference image Gref are stored. As used herein the image data Dref may also be referred to as “reference data”.

The auxiliary data A is data specifying a combination of an area Rn of the reference image Gref and the pitch n corresponding to the key 21. The area Rn is an area in which each key 21 of the reference instrument exists. As used herein, the area Rn may also be referred to as a “unit area”. That is, the auxiliary data A can also be said to be data defining the unit area Rn corresponding to each pitch n in the reference image Gref.

In the transformation from the position c[h, f] in the x-y coordinate system to the position C[h, f] in the X-Y coordinate system, projective transformation using a transformation matrix W, as expressed by the following Equation (2), is used. The symbol X in Equation (2) means a coordinate on an X-axis, and the symbol Y means a coordinate on a Y-axis in the X-Y coordinate system. The symbol s is an adjustment value for matching the scale between the x-y coordinate system and the X-Y coordinate system.

$$( \begin{matrix}X \\ Y \\ s\end{matrix} ) = W ( \begin{matrix}x \\ y \\ 1\end{matrix} ) \qquad ( 2 )$$

Matrix Generation Unit 312

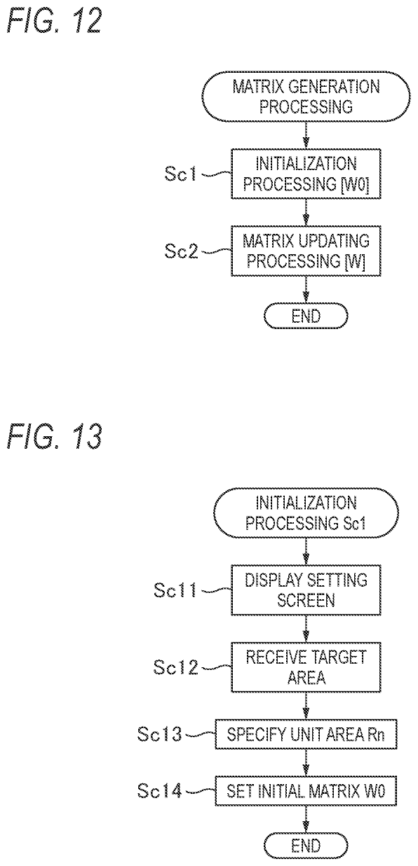

The matrix generation unit 312 shown in FIG. 3 generates the transformation matrix W of Equation (2) to be applied to the projective transformation performed by the projective transformation unit 314. FIG. 12 is a flowchart illustrating a specific procedure of processing of generating the transformation matrix W by the matrix generation unit 312. As used herein, the processing may also be referred to as “matrix generation processing”. The matrix generation processing of the first embodiment is executed with the performance image G2 (image data D2) after the image extraction processing as a processing target. According to the above configuration, as compared with a configuration in which the matrix generation processing is executed with the entire performance image G1 including areas other than the specific area B as a processing target, an appropriate transformation matrix W can be generated to approximate the keyboard image g1 to the reference image Gref with high accuracy.

The matrix generation processing includes initialization processing Sc1 and matrix updating processing Sc2. The initialization processing Sc1 is processing of setting an initial matrix W0, which is an initial setting of the transformation matrix W. Details of the initialization processing Sc1 will be described later.

The matrix updating processing Sc2 is processing of generating a transformation matrix W by iteratively updating the initial matrix W0. That is, the projective transformation unit 314 iteratively updates the initial matrix W0 to generate the transformation matrix W such that the keyboard image g1 of the performance image G2 approximates the reference image Gref by projective transformation using the transformation matrix W. For example, the transformation matrix W is generated so that a coordinate X/s on the X-axis of a specific point in the reference image Gref approximates or matches a coordinate x on the x-axis of a point corresponding to the point in the keyboard image g1, and a coordinate Y/s on the Y axis of a specific point in the reference image Gref approximates or matches a coordinate y on the y axis of a point corresponding to the point in the keyboard image g1. That is, the transformation matrix W is generated so that a coordinate of the key 21 corresponding to a specific pitch in the keyboard image g1 is transformed into a coordinate of the key 21 corresponding to the pitch in the reference image Gref by the projective transformation to which the transformation matrix W is applied. An element (matrix generation unit 312) for generating the transformation matrix W is implemented by the control device 11 executing the matrix updating processing Sc2 illustrated above.

As the matrix updating processing Sc2, processing (such as the Scale-Invariant Feature Transform (SIFT)) of updating the transformation matrix W so that an image feature amount of the reference image Gref and that of the keyboard image g1 approximate each other is assumed. However, in the keyboard image g1, since a pattern in which the plurality of keys 21 are arranged in the similar manner is repeated, there is a possibility that the transformation matrix W cannot be properly estimated in the embodiment of using the image feature amount.

Considering the above circumstances, in the matrix updating processing Sc2, the matrix generation unit 312 of the first embodiment iteratively updates the initial matrix W0 so as to increase (ideally maximize) an enhanced correlation coefficient (ECC) between the reference image Gref and the keyboard image g1. According to the present embodiment, as compared with the above-described configuration using the image feature amount, it is possible to generate an appropriate transformation matrix W capable of approximating the keyboard image g1 to the reference image Gref with high accuracy. The generation of the transformation matrix W using the enhanced correlation coefficient is also disclosed in Georgios D. Evangelidis and Emmanouil Z. Psarakis, “Parametric Image Alignment Using Enhanced Correlation Coefficient Maximization”, IEEE TRANSACTIONS ON PATTERN ANALYSIS AND MACHINE INTELLIGENCE, VOL. 30, NO. 10, October 2008. As described above, the enhanced correlation coefficient is suitable for generating the transformation matrix W used for the transformation of the keyboard image g1, but the transformation matrix W may be generated by processing such as SIFT so that the image feature amount of the reference image Gref and that of the keyboard image g1 approximate each other.

The projective transformation unit 314 shown in FIG. 3 executes projective transformation processing. The projective transformation processing includes projective transformation of the performance image G1 using the transformation matrix W generated by the matrix generation processing. By the projective transformation processing, the performance image G1 is transformed into an image captured under the same image capturing condition as the reference image Gref. As used herein, the captured image may also be referred to as a “transformed image”. For example, an area corresponding to the key 21 of a pitch n in the transformed image substantially matches the unit area Rn of the pitch n in the reference image Gref. The x-y coordinate system of the transformed image substantially matches the X-Y coordinate system of the reference image Gref. In the projective transformation processing described above, the projective transformation unit 314 transforms the position c[h, f] of each finger to the position C[h, f] in the X-Y coordinate system as expressed in Equation (2) described above. An element (projective transformation unit 314) for executing the projective transformation of the performance image G1 is implemented by executing the projective transformation processing illustrated above by the control device 11.

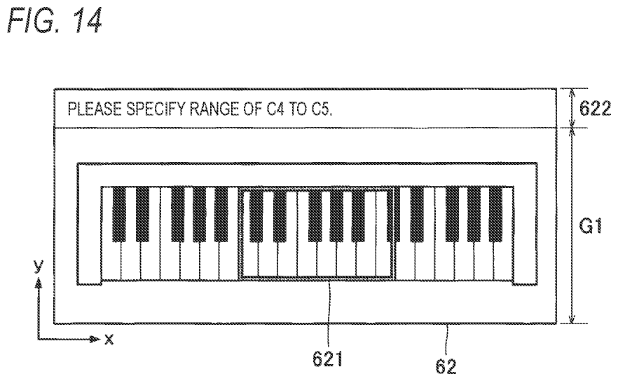

FIG. 13 is a flowchart illustrating a specific procedure of the initialization processing Sc1. When the initialization processing Sc1 is started, the projective transformation unit 314 causes the display device 14 to display a setting screen 62 illustrated in FIG. 14 (Sc11). The setting screen 62 includes the performance image G1 captured by the image capturing device 15 and an instruction 622 for the user. The instruction 622 is a message of selecting an area 621 corresponding to at least one specific pitch n in the keyboard image g1 in the performance image G1. As used herein, the area 621 may also be referred to as a “target area” and the specific pitch n may also be referred to as a “target pitch”. The user is able to select the target area 621 corresponding to the target pitch n in the performance image G1 by operating the operation device 13 while looking at the setting screen 62. The projective transformation unit 314 receives the selection of the target area 621 by the user (Sc12).

The projective transformation unit 314 specifies one or more unit areas Rn designated by the auxiliary data A for the target pitch n in the reference image Gref represented by the reference data Dref (Sc13). Then, the projective transformation unit 314 calculates, as the initial matrix W0, a matrix for applying a projective transformation to transform the target area 621 in the performance image G1 into one or more unit areas Rn specified from the reference image Gref (Sc14). As can be understood from the above description, the initialization processing Sc1 of the first embodiment is processing of setting the initial matrix W0 so as to approximate the target area 621 instructed by the user in the keyboard image g1 to the unit area Rn corresponding to the target pitch n in the reference image Gref by projective transformation using the initial matrix W0.

The setting of the initial matrix W0 is important for generating an appropriate transformation matrix W by the matrix updating processing Sc2. Especially in the embodiment of using the enhanced correlation coefficient for the matrix updating processing Sc2, there is a tendency that suitability of the initial matrix W0 is likely to affect suitability of the final transformation matrix W. In the first embodiment, the initial matrix W0 is set so that the target area 621 corresponding to the instruction from the user in the performance image G1 approximates the unit area Rn corresponding to the target pitch n in the reference image Gref. Therefore, it is possible to generate an appropriate transformation matrix W that can approximate the keyboard image g1 to the reference image Gref with high accuracy. In the first embodiment, the area designated by the user by operating the operation device 13 in the performance image G1 is used as the target area 621 for setting the initial matrix W0. Therefore, an appropriate initial matrix W0 can be generated while reducing the processing load, as compared with, for example, a configuration in which the area corresponding to the target pitch n in the performance image G1 is estimated by arithmetic processing. In the above description, the initialization processing Sc1 is executed for the performance image G1, but the initialization processing Sc1 may be executed for the performance image G2.

B: Operation Data Generation Unit 32

The operation data generation unit 32 shown in FIG. 3 generates the operation data Q using the performance data P generated by the keyboard unit 20 and the finger position data F generated by the finger position data generation unit 31, as described above. The operation data Q is generated every unit period. The operation data generation unit 32 of the first embodiment includes a probability calculation unit 321 and a fingering estimation unit 322. In the above description, one finger of the user is represented by a combination of the variable h and the variable f, but in the following description, one finger of the user is represented by the finger number k (k=1 to 10). Therefore, the position C[h, f] specified for each finger by the finger position data F is denoted as a position C[k] in the following description.

Probability Calculation Unit 321

The probability calculation unit 321 calculates, for each finger number k, a probability p that the pitch n specified by the performance data P is played by the finger with each finger number k. The probability p is an index of a probability (likelihood) that the finger with the finger number k operates the key 21 with the pitch n. The probability calculation unit 321 calculates the probability p in accordance with whether the position C[k] of the finger with the finger number k exists within the unit area Rn of the pitch n. The probability p is calculated for each unit period on the time axis. Specifically, when the performance data P specifies the pitch n, the probability calculation unit 321 calculates the probability p (C[k]|ηk=n) by the calculation of Equation (3) exemplified below.

$$p ( C [ k ] \vert {η}_{k} = n ) = v ( 0 , {σ}^{2} E ) * \frac{I ( C [ k ] ∈ {R}_{n} )}{\vert {R}_{n} \vert} \qquad ( 3 )$$

The condition “ηk=n” in the probability p (C[k]|ηk=n) means a condition that the finger with the finger number k plays the pitch n. That is, the probability p (C[k]|ηk=n) means a probability that the position C[k] is observed for the finger under the condition that the finger with the finger number k plays the pitch n.

The symbol I (C[k]∈Rn) in Equation (3) is an indicator function that is set to a numerical value of “1” when the position C[k] exists within the unit area Rn, and is set to a numerical value of “0” when the position C[k] exists outside the unit area Rn. The symbol |Rn| means an area of the unit area Rn. The symbol v (0, σ²E) means observation noise, and is expressed by a normal distribution of a mean 0 and a variance σ². The symbol E is a unit matrix of 2 rows and 2 columns. The symbol * means a convolution the observation noise v (0, σ²E).

As can be understood from the above description, the probability p (C[k]|ηk=n) calculated by the probability calculation unit 321 is a probability that, under a condition that the pitch n specified by the performance data P is played by a finger with the finger number k, the position of the finger is the position C[k] specified by the finger position data F for the finger. Therefore, the probability p (C[k]|ηk=n) is maximized when the position C[k] of the finger with the finger number k is within the unit area Rn in a playing state, and decreases as the position C[k] is further away from the unit area Rn.

On the other hand, when the performance data P does not specify any pitch n, that is, when the user does not operate any of the N keys 21, the probability calculation unit 321 calculates the probability p (C[k]|ηk=0) of each finger by the following Equation (4).

$$p ( C [ k ] \vert {η}_{k} = 0 ) = \frac{1}{\vert R \vert} \qquad ( 4 )$$

The symbol |R| in Equation (4) means a total area of N unit areas R1 to RN in the reference image Gref. As can be understood from Equation (4), when the user does not operate any key 21, the probability p (C[k]|ηk=0) is set to a common numerical value (1/|R|) for all finger number k.

As described above, within a period in which the performance data P specifies the pitch n, a plurality of probabilities p (C[k]|ηk=n) corresponding to different fingers are calculated for each unit period on the time axis. On the other hand, in each unit period in a period in which the performance data P does not specify any pitch n, the plurality of probabilities p (C[k]|ηk=0) corresponding to the different fingers is a sufficiently small fixed value (1/|R|).

Fingering Estimation Unit 322

The fingering estimation unit 322 estimates the fingering of the user. Specifically, the fingering estimation unit 322 estimates, based on the probability p (C[k]|ηk=n) of each finger, the finger (finger number k) that plays the pitch n specified by the performance data P. The fingering estimation unit 322 estimates the finger number k (generates the operation data Q) every time the probability p (C[k]|ηk=n) of each finger is calculated (that is, for every unit period). Specifically, the fingering estimation unit 322 specifies the finger number k corresponding to the maximum value among the plurality of probabilities p (C[k]|ηk=n) corresponding to the different fingers. Then, the fingering estimation unit 322 generates the operation data Q that specifies the pitch n specified by the performance data P and the finger number k specified from the probability p (C[k]|ηk=n).

When the maximum value among the plurality of probabilities p (C[k]|ηk=n) falls below a predetermined threshold within the period in which the performance data P specifies the pitch n, it means that reliability of a fingering estimation result is low. Therefore, the fingering estimation unit 322 sets the finger number k to an invalid value meaning invalidity of the estimation result in the unit period in which the maximum value among the plurality of probabilities p (C[k]|ηk=n) is below the threshold. For the note with the finger number k set to an invalid value, the display control unit 41 displays the note image 611 in a manner different from the normal note image 611, as illustrated in FIG. 4, and display a sign “??”, which means that the estimation result of the finger number k is invalid. The configuration and operation of the operation data generation unit 32 are as described above.

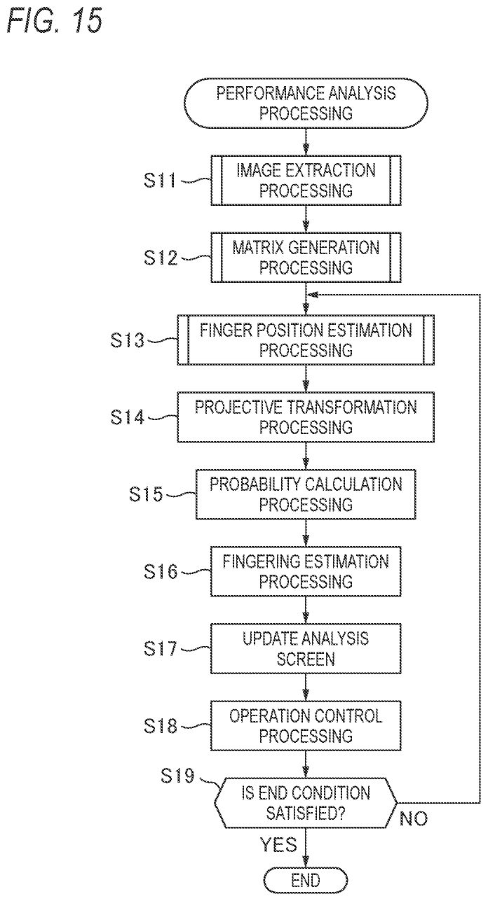

FIG. 15 is a flowchart illustrating a specific procedure of processing executed by the control device 11. As used herein, the processing may also be referred to as “performance analysis processing”. For example, the performance analysis processing is started in response to the user giving an instruction to the operation device 13.

When the performance analysis processing is started, the control device 11 (image extraction unit 311) executes the image extraction processing shown in FIG. 9 (S11). That is, the control device 11 generates the performance image G2 by extracting the specific area B including the keyboard image g1 and the finger image g2 from the performance image G1. The image extraction processing includes the area estimation processing Sb1 and the area extraction processing Sb2 as described above.

After executing the image extraction processing, the control device 11 (matrix generation unit 312) executes the matrix generation processing shown in FIG. 12 (S12). That is, the control device 11 generates the transformation matrix W by iteratively updating the initial matrix W0 so as to increase the enhanced correlation coefficient between the reference image Gref and the keyboard image g1. The matrix generation processing includes the initialization processing Sc1 and the matrix updating processing Sc2, as described above.

After the transformation matrix W is generated, the control device 11 repeats processing (S13 to S19) exemplified below for each unit period. First, the control device 11 (finger position estimation unit 313) executes the finger position estimation processing shown in FIG. 6 (S13). That is, the control device 11 estimates the position c[h, f] of each finger of the left hand and the right hand of the user by analyzing the performance image G1. As described above, the finger position estimation processing includes the image analysis processing Sa1, the left-right determination processing Sa2, and the interpolation processing Sa3.

The control device 11 (projective transformation unit 314) executes the projective transformation processing (S14). That is, the control device 11 generates the transformed image by projective transformation of the performance image G1 using the transformation matrix W. In the projective transformation processing, the control device 11 transforms the position c[h, f] of each finger of the user into the position C[h, f] in the X-Y coordinate system, and generates the finger position data F representing the position C[h, f] of each finger.

After generating the finger position data F by the above processing, the control device 11 (probability calculation unit 321) executes the probability calculation processing (S15). That is, the control device 11 calculates the probability p (C[k]|ηk=n) that the pitch n specified by the performance data P is played by each finger with the finger number k. Then, the control device 11 (fingering estimation unit 322) executes the fingering estimation processing (S16). That is, the control device 11 estimates the finger number k of the finger that plays the pitch n from the probability p (C[k]|ηk=n) of each finger, and generates the operation data Q that specifies the pitch n and the finger number k.

After the operation data Q is generated by the above processing, the control device 11 (display control unit 41) updates the analysis screen 61 in accordance with the operation data Q (S17). The control device 11 (operation control unit 42) executes the operation control processing in FIG. 5 (S18). That is, the control device 11 executes the first processing of reproducing the sound of the first timbre when the operation data Q specifies the finger of the left hand, and executes the second processing of reproducing the sound of the second timbre when the operation data Q specifies the finger of the right hand.

The control device 11 determines whether a predetermined end condition is satisfied (S19). For example, when the user inputs an instruction to end the performance analysis processing by operating the operation device 13, the control device 11 determines that the end condition is satisfied. If the end condition is not satisfied (S19: NO), the control device 11 repeats the processing after the finger position estimation processing (S13 to S19) for the immediately following unit period. On the other hand, if the end condition is satisfied (S19: YES), the control device 11 ends the performance analysis processing.

As described above, in the first embodiment, the finger position data F generated by analyzing the performance image G1 and the performance data P representing the performance by the user are used to generate the operation data Q. Therefore, the fingering can be estimated with high accuracy compared with a configuration in which the fingering is estimated only from one of the performance data P and the performance image G1.

In the first embodiment, the position c[h, f] of each finger estimated by the finger position estimation processing is transformed using the transformation matrix W for the projective transformation that approximates the keyboard image g1 to the reference image Gref. That is, the position C[h, f] of each finger is estimated based on the reference image Gref. Therefore, the fingering can be estimated with high accuracy compared with a configuration in which the position c[h, f] of each finger is not transformed to a position based on the reference image Gref.

In the first embodiment, the specific area B including the keyboard image g1 is extracted from the performance image G1. Therefore, as described above, it is possible to generate an appropriate transformation matrix W that can approximate the keyboard image g1 to the reference image Gref with high accuracy. Extracting the specific area B can improve usability of the performance image G1. In the first embodiment, the specific area B including the keyboard image g1 and the finger image g2 is particularly extracted from the performance image G1. Therefore, it is possible to generate the performance image G2 in which appearance of the keyboard unit 20 and appearance of the fingers of the user can be efficiently and visually confirmed.

### 2: Second Embodiment

The second embodiment will be described. In each embodiment exemplified below, elements having the same functions as those of the first embodiment are denoted by the same reference numerals as those used in the description of the first embodiment, and detailed descriptions thereof are appropriately omitted.

The keyboard unit 20 of the second embodiment can detect an intensity Λin of operation on each key 21 by the user. As used herein, the intensity Λin may be referred to as an “operation intensity”. For example, in the keyboard unit 20, each key 21 is provided with a displacement sensor that detects displacement of the key 21. As the operation intensity Λin for the key 21, a displacement velocity calculated from a time change in displacement detected by each displacement sensor for each key 21 is used. The performance data P specifies the pitch n and the operation intensity Λin of each key 21 for each operation on the key 21 by the user. The control device 11 may calculate the operation intensity Λin by analyzing a detection signal output by each displacement sensor. For example, in an embodiment in which a pressure sensor for detecting a pressure for operating the key 21 is provided for each key 21, the pressure detected by the pressure sensor may be used as the operation intensity Λin.

The sound source device 16 of the second embodiment can change an intensity Λout of the reproduced sound by the user. As used herein, the intensity Λout may be referred to as “reproduction intensity”. The reproduction intensity Λout is, for example, volume.

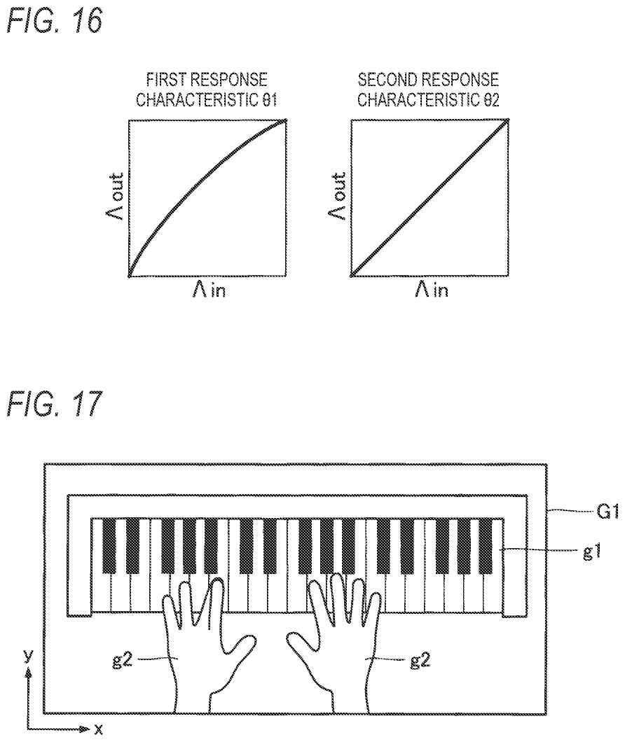

FIG. 16 is an explanatory diagram relating to a relation θ between the operation intensity Λin and the reproduction intensity Λout. As used herein, the relation θ may be referred to as “response characteristic”. A first response characteristic θ1 and a second response characteristic θ2 are shown together in FIG. 16. The response characteristic θ (θ1, θ2) is a touch curve (or velocity curve) representing the relation between the operation intensity θin and the reproduction intensity θout. The response characteristic θ roughly defines the relation between the operation intensity Λin and the reproduction intensity Λout so that the greater the operation intensity Λin, the greater the reproduction intensity Λout. The first response characteristic θ1 and the second response characteristic θ2 are stored in the storage device 12.

The first response characteristic θ1 and the second response characteristic θ2 are different. Specifically, the numerical value of the reproduction intensity Λout corresponding to each numerical value of the operation intensity Λin differs between the first response characteristic θ1 and the second response characteristic θ2. Specifically, the numerical value of the reproduction intensity Λout corresponding to each numerical value of the operation intensity Λin under the first response characteristic θ1 exceeds the numerical value of the reproduction intensity Λout corresponding to the numerical value of the operation intensity Λin under the second response characteristic θ2. That is, in the first response characteristic θ1, even when the operation intensity Λin is small, there is a tendency that the reproduction intensity Λout is likely to be set to a larger numerical value than in the second response characteristic θ2. As can be understood from the above description, the response characteristic θ affects an operational feeling (touch response) of the keyboard unit 20 by the user. For example, the operation intensity Λin required to reproduce a sound with a desired reproduction intensity Λout of the user (that is, a weight of the key 21 perceived by the user) is different between the first response characteristic θ1 and the second response characteristic θ2. The first response characteristic θ1 is an example of a “first relation”, and the second response characteristic θ2 is an example of a “second relation”.

As in the first embodiment, the operation control unit 42 of the second embodiment executes the first processing when the operation data Q represents an operation with the finger of the left hand, and executes the second processing when the operation data Q represents an operation with the finger of the right hand. However, in the second embodiment, the contents of the first processing and the second processing are different from those in the first embodiment.

The first processing is processing of controlling sound reproduction by the reproduction system 18 using the first response characteristic θ1. Specifically, the operation control unit 42 specifies the reproduction intensity Λout corresponding to the operation intensity Λin specified by the performance data P under the first response characteristic θ1, and sends, to the sound source device 16, a sound generation instruction including designation of the pitch n played by the user and the reproduction intensity Λout. The sound source device 16 generates the sound signal S representing the reproduction intensity Λout and the pitch n in response to the sound generation instruction from the operation control unit 42. By supplying the sound signal S to the sound emitting device 17, the sound of the pitch n is reproduced from the sound emitting device 17 with the reproduction intensity Λout. That is, the first processing is processing of causing the reproduction system 18 to reproduce the sound with the reproduction intensity Λout having a relation of the first response characteristic θ1 with respect to the operation intensity Λin by the user.

The second processing is processing of controlling sound reproduction by the reproduction system 18 using the second response characteristic θ2. Specifically, the operation control unit 42 specifies the reproduction intensity Λout corresponding to the operation intensity Λin specified by the performance data P under the second response characteristic θ2, and sends, to the sound source device 16, a sound generation instruction including designation of the pitch n played by the user and the reproduction intensity Λout. Therefore, the sound of the pitch n is reproduced from the sound emitting device 17 with the reproduction intensity Λout specified from the second response characteristic θ2. That is, the second processing is processing of causing the reproduction system 18 to reproduce the sound with the reproduction intensity Λout having a relation of the second response characteristic θ2 with respect to the operation intensity Λin by the user.

As can be understood from the above description, the sound of the pitch n corresponding to the key 21 operated by the user with the left hand is reproduced with the reproduction intensity Λout having the relation of the first response characteristic θ1 with respect to the operation intensity Λin, and the sound of the pitch n corresponding to the key 21 operated by the user with the right hand is reproduced with the reproduction intensity Λout having the relation of the second response characteristic θ2 with respect to the operation intensity Λin. That is, the operational feeling perceived by the user differs depending on whether the user operates the key 21 with the left hand or the right hand. For example, when the user plays with the left hand, the sound is reproduced at a volume desired by the user by pressing keys weaker than when playing with the right hand.

The second embodiment also achieves effects including the same effect as the first embodiment. In the second embodiment, the sound is reproduced with different reproduction intensities Λout (for example, different volumes) with respect to the operation intensity Λin depending on whether the operation data Q represents an operation with the finger of the left hand or represents an operation with the finger of the right hand. Therefore, it is possible to make the operational feeling (touch response) different between the operation with the left hand and the operation with the right hand.

### 3: Third Embodiment

The third embodiment will be described. In each embodiment exemplified below, elements having the same functions as those of the first embodiment are denoted by the same reference numerals as those used in the description of the first embodiment, and detailed descriptions thereof are appropriately omitted.

In the first embodiment, the probability p (C[k]|ηk=n) is calculated in accordance with whether the position C[k] of the finger with the finger number k exists within the unit area Rn of the pitch n. Assuming that only one finger exists in the unit area Rn, the fingering can be estimated with high accuracy even in the first embodiment. However, in an actual performance of the keyboard unit 20, it is assumed that the positions C[k] of a plurality of fingers exist within one unit area Rn.

For example, as illustrated in FIG. 17, when the user operates one key 21 with the middle finger of the left hand and moves the index finger of the left hand upward in the vertical direction, the middle finger and the index finger of the left hand overlap each other in the performance image G1. That is, the position C[k] of the middle finger and the position C[k] of the index finger of the left hand exist within one unit area Rn. In a playing method (finger crossing) in which the user operates the key 21 with one finger and the other finger crosses over or below the one finger, a plurality of fingers may overlap each other. When a plurality of fingers overlap each other within one unit area Rn as described above, the method of the first embodiment may not be able to estimate the fingering with high accuracy. The third embodiment provides a solution for the above problem. Specifically, in the third embodiment, a positional relationship among a plurality of fingers and fluctuation (variation) over time in the position of each finger are taken into consideration in the fingering estimation.

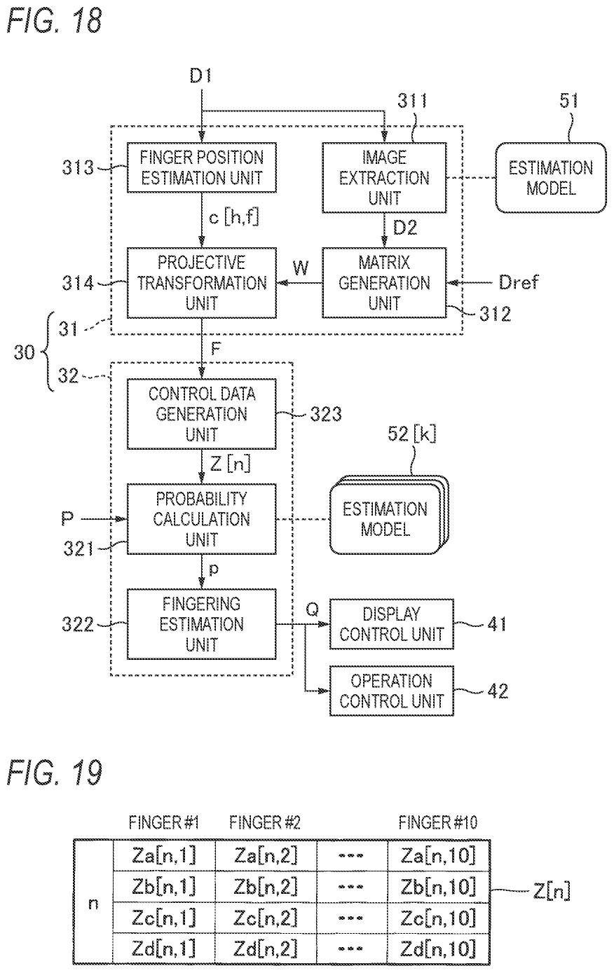

FIG. 18 is a block diagram illustrating a functional configuration of the information processing system 10 according to the third embodiment. The information processing system 10 of the third embodiment has a configuration in which a control data generation unit 323 is provided in addition to the same elements as those of the first embodiment.

The control data generation unit 323 generates N pieces of control data Z[1] to Z[N] corresponding to the different pitches n. FIG. 19 is a schematic diagram of control data Z[n] corresponding to an arbitrary pitch n. The control data Z[n] is vector data representing a feature of a position C′[k] of each finger relative to the unit area Rn of the pitch n. As used herein, the position C′[k] may also be referred to as a “relative position”. The relative position C′[k] is information obtained by transforming the position C[k] represented by the finger position data F into a position relative to the unit area Rn.

In addition to the pitch n, the control data Z[n] corresponding to the pitch n includes an position mean Za[n, k], a position variance Zb[n, k], a velocity mean Zc[n, k], and a velocity variance Zd[n, k] for each of the plurality of fingers. The position mean Za[n, k] is a mean of the relative positions C′[k] within a period of a predetermined length including the current unit period. As used herein the period of the predetermined length may also be referred to as an “observation period”. The observation period is, for example, a period corresponding to a plurality of unit periods arranged forward on the time axis with the current unit period assumed as a tail end. The position variance Zb[n, k] is a variance of the relative positions C′[k] within the observation period. The velocity mean Zc[n, k] is a mean of velocities (that is, rate of change) at which the relative position C′[k] changes within the observation period. The velocity variance Zd[n, k] is a variance of the velocities at which the relative position C′[k] changes within the observation period.

As described above, the control data Z[n] includes information (Za[n, k], Zb[n, k], Zc[n, k], and Zd[n, k]) about the relative position C′[k] for each of the plurality of fingers. Therefore, the control data Z[n] is data reflecting the positional relationship among the plurality of fingers of the user. The control data Z[n] also includes information (Zb[n, k], Zd[n, k]) about variation in the relative position C′[k] for each of the plurality of fingers. Therefore, the control data Z[n] is data reflecting the variation over time in the position of each finger.

In the probability calculation processing by the probability calculation unit 321 of the third embodiment, a plurality of estimation models 52[k] (52[1] to 52[10]) prepared in advance for different fingers are used. The estimation model 52[k] of each finger is a trained model that learns a relation between the control data Z[n] and a probability p[k] of the finger. The probability p[k] is an index (probability) of a likelihood of playing the pitch n specified by the performance data P by the finger with the finger number k. The probability calculation unit 321 calculates the probability p[k] by inputting the N pieces of control data Z[1] to Z[N] to the estimation model 52[k] for each of the plurality of fingers.

The estimation model 52[k] corresponding to any one finger number k is a logistic regression model represented by Equation (5) below.

$$p [ k ] = \frac{1}{1 + exp \{ - ( {β}_{k} + {\sum }_{n} {ω}_{k , n} Z [ n ] ) \}} \qquad ( 5 )$$

The variable βk and the variable ωk, n in Equation (5) are set by machine learning by the machine learning system 900. That is, each estimation model 52[k] is established by machine learning by the machine learning system 900, and each estimation model 52[k] is provided to the information processing system 10. For example, the variable βk and the variable ωk, n of each estimation model 52[k] are sent from the machine learning system 900 to the information processing system 10.

A finger positioned above a key-pressing finger or a finger moving above or below a key-pressing finger tends to move more easily than the key-pressing finger. Considering the above tendency, the estimation model 52[k] learns the relation between the control data Z[n] and the probability p[k] so that the probability p[k] becomes small for the fingers with a high rate of change in the relative position C′[k]. The probability calculation unit 321 calculates a plurality of probabilities p[k] regarding different fingers for each unit period by inputting the control data Z[n] to each of the plurality of estimation models 52[k].

The fingering estimation unit 322 estimates the fingering of the user through the fingering estimation processing to which the plurality of probabilities p[k] are applied. Specifically, the fingering estimation unit 322 estimates the finger (finger number k) that plays the pitch n specified by the performance data P from the probability p[k] of each finger. The fingering estimation unit 322 estimates the finger number k (generates the operation data Q) every time the probability p[k] of each finger is calculated (that is, for every unit period). Specifically, the fingering estimation unit 322 specifies the finger number k corresponding to the maximum value among the plurality of probabilities p[k] corresponding to the different fingers. Then, the fingering estimation unit 322 generates the operation data Q that specifies the pitch n specified by the performance data P and the finger number k specified from the probability p[k].

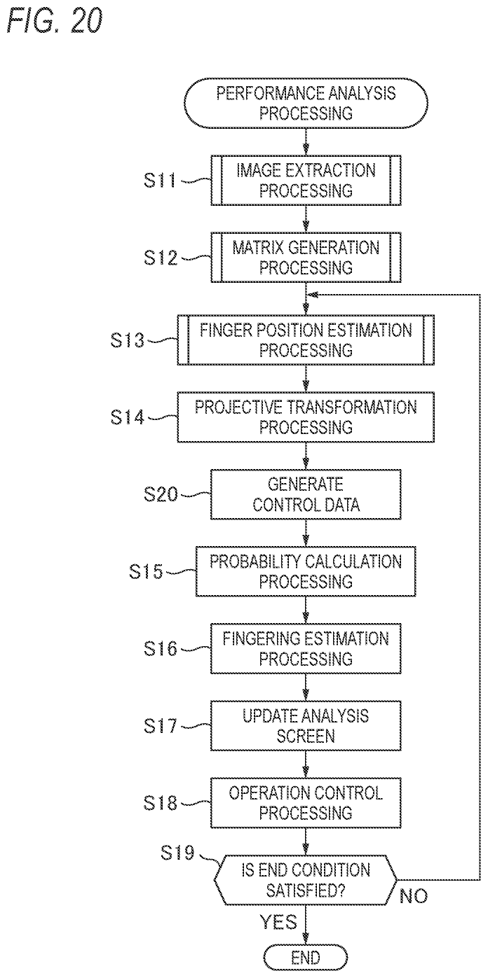

FIG. 20 is a flowchart illustrating a specific procedure of the performance analysis processing in the third embodiment. In the performance analysis processing of the third embodiment, generation of control data Z[n] (S20) is provided in addition to the same processing as in the first embodiment. Specifically, the control device 11 (control data generation unit 323) generates, based on the finger position data F (that is, the position C[h, f] of each finger) generated by the finger position data generation unit 31, N pieces of the control data Z[1] to Z[N] corresponding to the different pitches n.

The control device 11 (probability calculation unit 321) calculates the probability p[k] corresponding to the finger number k by the probability calculation processing of inputting the N pieces of control data Z[1] to Z[N] into each estimation model 52[k] (S15). The control device 11 (fingering estimation unit 322) estimates the fingering of the user by the fingering estimation processing to which the plurality of probabilities p[k] are applied (S16). The operations (S11 to S14, S17, and S18) of elements other than the operation data generation unit 32 are the same as those in the first embodiment.

The third embodiment also achieves effects including the same effect as the first embodiment. In the third embodiment, the control data Z[k] input to the estimation model 52[k] includes the mean Za[n, k] and the variance Zb[n, k] of the relative position C′[k], and the mean Zc[n, k] and the variance Zd[n, k] of the rate of change in the relative position C′[k] of each finger. Therefore, even when a plurality of fingers overlap each other due to, for example, finger crossing, the fingering of the user can be estimated with high accuracy. The third embodiment may be similarly applied to the second embodiment.

In the above description, the logistic regression model is exemplified as the estimation model 52[k], but the type of the estimation model 52[k] is not limited to the above example. For example, a statistical model such as a multilayer perceptron may be used as the estimation model 52[k]. A deep neural network such as a convolutional neural network or a recurrent neural network may also be used as the estimation model 52[k]. A combination of a plurality of types of statistical models may be used as the estimation model 52[k]. The various estimation models 52[k] exemplified above are comprehensively expressed as trained models that learn the relation between the control data Z[n] and the probability p[k].

### 4: Fourth Embodiment

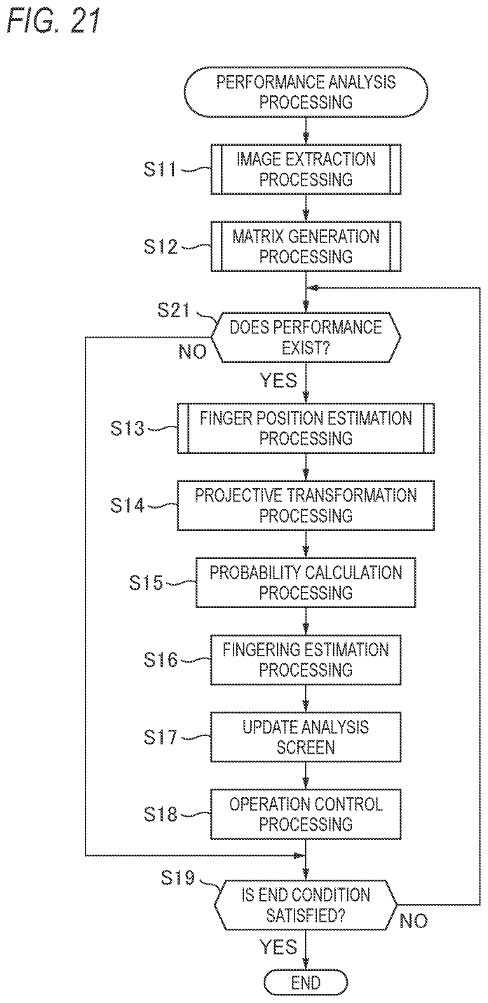

FIG. 21 is a flowchart illustrating a specific procedure of the performance analysis processing in the fourth embodiment. After executing the image extraction processing and the matrix generation processing, the control device 11 refers to the performance data P to determine whether the user is playing the keyboard unit 20 (S21). Specifically, the control device 11 determines whether any one of the plurality of keys 21 of the keyboard unit 20 is being operated.

If the keyboard unit 20 is being played (S21: YES), the control device 11 generates the finger position data F (S13 and S14), generates the operation data Q (S15 and S16), updates the analysis screen 61 (S17), and executes the operation control processing (S18) as in the first embodiment. On the other hand, if the keyboard unit 20 is not being played (S21: NO), the control device 11 proceeds to the processing to the step S19. That is, the generation of the finger position data F (S13 and S14), the generation of the operation data Q (S15 and S16), the updating of the analysis screen 61 (S17), and the operation control processing (S18) will not be executed.

The fourth embodiment also achieves effects including the same effect as the first embodiment. In the fourth embodiment, when the keyboard unit 20 is not being played, the generation of the finger position data F and the operation data Q is stopped. Therefore, the processing load necessary for generating the operation data Q can be reduced compared with a configuration in which the generation of the finger position data F is continued regardless of whether the keyboard unit 20 is being played. The fourth embodiment can also be applied to the second embodiment or the third embodiment.

### 5: Fifth Embodiment

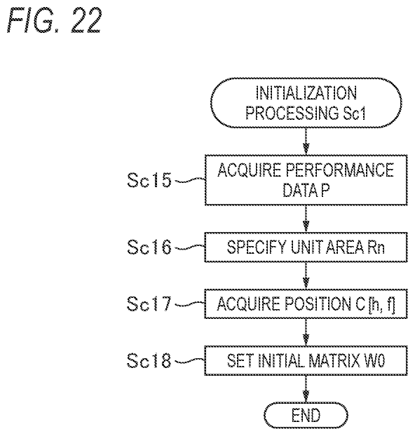

The fifth embodiment is an embodiment in which the initialization processing Sc1 in each of the above-described embodiments is modified. FIG. 22 is a flowchart illustrating a specific procedure of the initialization processing Sc1 executed by the control device 11 (matrix generation unit 312) of the fifth embodiment.

When the initialization processing Sc1 is started, the user operates, by a specific finger, the key 21 corresponding to a desired pitch n among the plurality of keys 21 of the keyboard unit 20. As used herein, the desired pitch may also be referred to as a “specific pitch”. The specific finger is, for example, a finger (for example, the index finger of the right hand) of which the user is notified by the display on the display device 14 or an instruction manual or the like of the electronic musical instrument 100. As a result of the performance by the user, the performance data P specifying the specific pitch n is supplied from the keyboard unit 20 to the information processing system 10. The control device 11 acquires the performance data P from the keyboard unit 20, thereby recognizing the performance of the specific pitch n by the user (Sc15). The control device 11 specifies the unit area Rn corresponding to the specific pitch n among the N unit areas R1 to RN of the reference image Gref (Sc16).

On the other hand, the finger position data generation unit 31 generates the finger position data F through the finger position estimation processing. The finger position data F includes the position C[h, f] of the specific finger used by the user to play the specific pitch n. The control device 11 acquires the finger position data F to specify the position C[h, f] of the specific finger (Sc17).

The control device 11 sets the initial matrix W0 by using the unit area Rn corresponding to the specific pitch n and the position C[h, f] of the specific finger represented by the finger position data F (Sc18). That is, the control device 11 sets the initial matrix W0 so that the position C[h, f] of the specific finger represented by the finger position data F approximates the unit area Rn of the specific pitch n in the reference image Gref. Specifically, as the initial matrix W0, a matrix for applying a projective transformation to transform the position C[h, f] of the specific finger into a center of the unit area Rn is set.

The fifth embodiment also achieves effects including the same effect as the first embodiment. In the fifth embodiment, when the user plays the desired specific pitch n with the specific finger, the initial matrix W0 is set so that the position c[h, f] of the specific finger in the performance image G1 approximates a portion (unit area Rn) corresponding to the specific pitch n in the reference image Gref. Since the user only needs to play the desired pitch n, compared with the first embodiment in which the user needs to select the target area 621 by operating the operation device 13, working load required for the user to set the initial matrix W0 is reduced. On the other hand, according to the first embodiment in which the user designates the target area 621, it is not necessary to estimate the position C[h, f] of the finger of the user, and therefore, an appropriate initial matrix W0 can be set while reducing influence of estimation error as compared with the third embodiment. The fifth embodiment can be similarly applied to the second embodiment to the fourth embodiment.

In the fifth embodiment, it is assumed that the user plays one specific pitch n, but

the user may play a plurality of specific pitches n with specific fingers. The control device 11 sets the initial matrix W0 for each of the plurality of specific pitches n so that the position C[h, f] of the specific finger when playing the specific pitch n approximates the unit area Rn of the specific pitch n.

### 6: Modifications

Specific modified aspects added to the above-exemplified aspects will be exemplified below. Two or more aspects freely selected from the following examples may be combined as appropriate within a mutually consistent range.
(1) In each of the above-described embodiments, the matrix generation processing (FIG. 9) is executed with the performance image G2 after the image extraction processing as a processing target, but the matrix generation processing may be executed with the performance image G1 captured by the image capturing device 15 as a processing target. That is, the image extraction processing (the image extraction unit 311) for generating the performance image G2 from the performance image G1 may be omitted.

In each of the above embodiments, the finger position estimation processing using the performance image G1 is exemplified, but the finger position estimation processing may be executed using the performance image G2 after the image extraction processing. That is, the position C[h, f] of each finger of the user may be estimated by analyzing the performance image G2. In each of the above embodiments, the projective transformation processing is executed for the performance image G1, but the projective transformation processing may be executed for the performance image G2 after the image extraction processing. That is, the transformed image may be generated by performing projective transformation on the performance image G2.
(2) In each of the above embodiments, the position c[h, f] of each finger of the user is transformed into the position C[h, f] in the X-Y coordinate system by projective transformation processing, but the finger position data F representing the position c[h, f] of each finger may be generated. That is, the projective transformation processing (projective transformation unit 314) for transforming the position c[h, f] into the position C[h, f] may be omitted.
(3) In each of the above embodiments, the transformation matrix W generated immediately after the start of the performance analysis processing is used continuously in subsequent processing, but the transformation matrix W may be updated at an appropriate timing during the execution of the performance analysis processing. For example, when the position of the image capturing device 15 with respect to the keyboard unit 20 is changed, it is assumed that the transformation matrix W may be updated. Specifically, when a change in the position of the image capturing device 15 is detected by analyzing the performance image G1, or when the user instructs a change in the position of the image capturing device 15, the transformation matrix W will be updated. As used herein, the change in the position may also be referred to as a “positional change”.

Specifically, the matrix generation unit 312 generates a transformation matrix δ indicating the positional change (displacement) of the image capturing device 15. For example, a relation expressed by the following Equation (6) is assumed for a coordinate (x, y) in the performance image G (G1, G2) after the positional change.

$$( \begin{matrix}{x}^{′} \\ {y}^{′} \\ ε\end{matrix} ) = δ ( \begin{matrix}x \\ y \\ 1\end{matrix} ) \qquad ( 6 )$$

The matrix generation unit 312 generates the transformation matrix δ so that a coordinate x′/ε calculated by Equation (6) from an x-coordinate of a specific position after the positional change approximates or matches an x-coordinate of a position corresponding to the position in the performance image G before the positional change, and a coordinate y′/ε calculated by Equation (6) from a y-coordinate of the specific point after the positional change approximates or matches a y-coordinate of the position corresponding to the position in the performance image G before the positional change. Then, the matrix generation unit 312 generates, as the initial matrix W0, a product Wδ of the transformation matrix W before the positional change and the transformation matrix δ indicating the positional change, and updates the initial matrix W0 by the matrix updating processing Sc2 to generate the transformation matrix W.

In the above configuration, the transformation matrix W after the positional change is generated using the transformation matrix W calculated before the positional change and the transformation matrix δ indicating the positional change. Therefore, it is possible to generate the transformation matrix W that can specify the position C[h, f] of each finger with high accuracy while reducing the load of the matrix generation processing.
(4) Specific contents of the first processing and the second processing are not limited to the examples in each of the above embodiments. For example, processing of applying a first sound effect to the sound signal S generated by the sound source device 16 may be executed as the first processing, and processing of applying a second sound effect different from the first sound effect to the sound signal S may be executed as the second processing. Examples of processing of applying a sound effect include equalizer that adjusts a signal level for each band of the sound signal S, distortion that distorts the timbre represented by the sound signal S, and compressor that reduces sections of the sound signal S in which the signal level is high.
(5) In each of the above-described embodiments, the electronic musical instrument 100 including the keyboard unit 20 is illustrated, but the present disclosure can be applied to any type of musical instrument. For example, for any musical instrument that can be manually operated by the user, such as a stringed instrument, a wind instrument, or a percussion instrument, each of the above embodiments can be similarly applied. A typical example of a musical instrument is the type of musical instrument played by the user by simultaneously moving his or her right hand and left hand.
(6) The information processing system 10 may be implemented by a server device that communicates with an information device such as a smartphone or a tablet terminal. For example, the performance data P generated by the keyboard unit 20 connected to the information device and the image data D1 generated by the image capturing device 15 mounted on or connected to the information device are sent from the information device to the information processing system 10. The information processing system 10 generates the operation data Q by executing the performance analysis processing on the performance data P and the image data D1 received from the information device, and sends the sound signal S generated by the sound source device 16 in accordance with the operation data Q to the information device.
(7) The functions of the information processing system 10 according to each of the above embodiments are implemented by cooperation of one or more processors constituting the control device 11 and the programs stored in the storage device 12. The programs according to the present disclosure may be provided in a form stored in a computer-readable recording medium and installed in a computer. The recording medium is, for example, a non-transitory recording medium, and is preferably an optical recording medium (optical disc) such as a CD-ROM, and may include any known type of recording medium such as a semiconductor recording medium or a magnetic recording medium. The non-transitory recording medium includes any recording medium other than transitory propagating signals, and does not exclude volatile recording media. In a configuration in which a distribution device distributes programs via a communication network, the storage device 12 that stores the programs in the distribution device corresponds to the above-described non-transitory recording medium.

### 7: Appendix

For example, the following configurations can be understood from the embodiments described above.

An information processing method according to one aspect (Aspect 1) of the present disclosure includes: generating operation data representing which of a plurality of fingers of a left hand and a right hand of a user operates a musical instrument, by analyzing a performance image indicating the plurality of fingers of the user who plays the musical instrument; and executing first processing in a case in which the operation data represents the musical instrument being operated with a finger of the left hand, and executing second processing different from the first processing in a case in which the operation data represents the musical instrument being operated with a finger of the right hand. In the above aspect, the operation data is generated by analyzing the performance image, and different processing is executed depending on whether the operation data represents an operation with the finger of the left hand or the finger of the right hand. Therefore, for example, even when the user plays with the left hand and the right hand close to each other or overlapping each other, or with a right arm and a left arm crossed (reversed in a left-right direction), a clear distinguishing can be made between the first processing corresponding to the operation with the left hand and the second processing corresponding to the operation with the right hand.

In a specific example (Aspect 2) of Aspect 1, the first processing is processing of reproducing a sound of a first timbre, and the second processing is processing of reproducing a sound of a second timbre different from the first timbre. In the above aspect, sounds with different timbres are reproduced depending on whether the operation data represents an operation with the finger of the left hand or the finger of the right hand. Therefore, it is possible to achieve diverse performance in which sounds with different timbres are reproduced by the operation with the left hand and the operation with the right hand.

In a specific example (Aspect 3) of Aspect 1, the first processing is processing of reproducing a sound with a reproduction intensity having a first relation with respect to an operation intensity by the user, and the second processing is processing of reproducing a sound with a reproduction intensity having a second relation with respect to an operation intensity by the user, the second relation being different from the first relation. In the above aspect, the sound is reproduced with different reproduction intensities (for example, different volumes) with respect to the operation intensity depending on whether the operation data represents an operation with the finger of the left hand or represents an operation with the finger of the right hand. Therefore, it is possible to make the operational feeling (touch response) different between the operation with the left hand and the operation with the right hand.

In a specific example (Aspect 4) of any one of Aspect 1 to Aspect 3, the generating of the operation data includes: generating finger position data representing a position of each of fingers of the right hand and a position of each of fingers of the left hand by analyzing the performance image, and generating the operation data using performance data representing performance by the user and the finger position data. In the above aspect, the finger position data generated by analyzing the performance image and the performance data representing the performance are used to generate the operation data. Therefore, it is possible to estimate with high accuracy with which finger of the user the musical instrument is operated, compared with a configuration in which the operation data is generated from only one of the performance data and the performance image.

In a specific example (Aspect 5) of Aspect 4, the generating the finger position data includes: image analysis processing of estimating a position of each of fingers of a first hand of the user and a position of each of fingers of a second hand of the user by analyzing the performance image, and left-right determination processing of determining that, of the first hand and the second hand, a hand with a thumb positioned on a left side of a little finger is the right hand, and a hand with a thumb positioned on a right side of a little finger is the left hand. In the above aspect, the position of each of fingers of the user can be distinguished between the right hand and the left hand by simple processing using a relation between the position of the thumb and the position of the little finger.

In a specific example (Aspect 6) of Aspect 4 or 5, the performance analysis method further includes: determining whether the musical instrument is played by the user in accordance with the performance data; and not generating the finger position data in a case in which the musical instrument is not played. In the above aspect, the generation of the finger position data is stopped in a case in which the musical instrument is not being played. Therefore, the processing load necessary for generating the operation data can be reduced compared with a configuration in which the generation of the finger position data is continued regardless of whether the musical instrument is being played.

An information processing system according to an aspect (Aspect 7) of the present disclosure includes: a performance analysis unit configured to generate operation data representing which of a plurality of fingers of a left hand and a right hand of a user operates a musical instrument, by analyzing a performance image indicating the plurality of fingers of the user who plays the musical instrument; and an operation control unit configured to execute first processing in a case in which the operation data represents the musical instrument being operated with a finger of the left hand, and execute second processing different from the first processing in a case in which the operation data represents the musical instrument being operated with a finger of the right hand.

A program according to an aspect (Aspect 8) of the present disclosure causes a computer system to function as: a performance analysis unit configured to generate operation data representing which of a plurality of fingers of a left hand and a right hand of a user operates a musical instrument, by analyzing a performance image indicating the plurality of fingers of the user who plays the musical instrument; and an operation control unit configured to execute first processing in a case in which the operation data represents the musical instrument being operated with a finger of the left hand, and execute second processing different from the first processing in a case in which the operation data represents the musical instrument being operated with a finger of the right hand.

What is claimed is:

1. An information processing method implemented by a computer system, the information processing method comprising:
generating operation data representing one or more fingers, of a plurality of fingers of a left hand and a right hand of a user, that operate a musical instrument, by analyzing a performance image indicating the plurality of fingers of the user who plays the musical instrument; and
executing first processing in a case where the operation data represents the musical instrument being operated with a finger of the left hand, and executing second processing different from the first processing in a case where the operation data represents the musical instrument being operated with a finger of the right hand.

2. The information processing method according to claim 1, wherein
the first processing is processing of reproducing a sound of a first timbre, and
the second processing is processing of reproducing a sound of a second timbre different from the first timbre.

3. The information processing method according to claim 2, wherein
the generating of the operation data includes:
generating finger position data representing a position of each finger of the right hand and a position of each finger of the left hand by analyzing the performance image, and
generating the operation data using performance data representing performance by the user and the finger position data.

4. The information processing method according to claim 1, wherein
the first processing is processing of reproducing a sound with a first reproduction intensity having a first relation with respect to an operation intensity by the user, and
the second processing is processing of reproducing a sound with a second reproduction intensity having a second relation with respect to the operation intensity by the user, the second relation being different from the first relation.

5. The information processing method according to claim 4, wherein
the generating of the operation data includes:
generating finger position data representing a position of each finger of the right hand and a position of each finger of the left hand by analyzing the performance image, and
generating the operation data using performance data representing performance by the user and the finger position data.

6. The information processing method according to claim 1, wherein
the generating of the operation data includes:
generating finger position data representing a position of each finger of the right hand and a position of each finger of the left hand by analyzing the performance image, and
generating the operation data using performance data representing performance by the user and the finger position data.

7. The information processing method according to claim 6, wherein
the generating of the finger position data includes:
image analysis processing of estimating a position of each finger of a first hand of the user and a position of each finger of a second hand of the user by analyzing the performance image, and
left-right determination processing of determining that, of the first hand and the second hand, a hand with a thumb positioned on a left side of a little finger is the right hand, and a hand with a thumb positioned on a right side of a little finger is the left hand.

8. The information processing method according to claim 7, further comprising:
determining whether the musical instrument is played by the user in accordance with the performance data; and
not generating the finger position data in a case where the musical instrument is not played.

9. The information processing method according to claim 6, further comprising:
determining whether the musical instrument is played by the user in accordance with the performance data; and
not generating the finger position data in a case where the musical instrument is not played.

10. An information processing system comprising:
a memory configured to store instructions; and
a processor communicatively connected to the memory and configured to execute the stored instructions to function as:
a performance analysis unit configured to generate operation data representing one or more fingers, of a plurality of fingers of a left hand and a right hand of a user, that operate a musical instrument, by analyzing a performance image indicating the plurality of fingers of the user who plays the musical instrument; and
an operation control unit configured to execute first processing in a case where the operation data represents the musical instrument being operated with a finger of the left hand, and execute second processing different from the first processing in a case where the operation data represents the musical instrument being operated with a finger of the right hand.

11. The information processing system according to claim 10, wherein
the first processing is processing of reproducing a sound of a first timbre, and
the second processing is processing of reproducing a sound of a second timbre different from the first timbre.

12. The information processing system according to claim 11, wherein
the performance analysis unit is configured to:
generate finger position data representing a position of each finger of the right hand and a position of each finger of the left hand by analyzing the performance image; and
generate the operation data using performance data representing performance by the user and the finger position data.

13. The information processing system according to claim 10, wherein
the first processing is processing of reproducing a sound with a first reproduction intensity having a first relation with respect to an operation intensity by the user, and
the second processing is processing of reproducing a sound with a second reproduction intensity having a second relation with respect to the operation intensity by the user, the second relation being different from the first relation.

14. The information processing system according to claim 13, wherein
the performance analysis unit is configured to:
generate finger position data representing a position of each finger of the right hand and a position of each finger of the left hand by analyzing the performance image; and
generate the operation data using performance data representing performance by the user and the finger position data.

15. The information processing system according to claim 10, wherein
the performance analysis unit is configured to:
generate finger position data representing a position of each finger of the right hand and a position of each finger of the left hand by analyzing the performance image; and
generate the operation data using performance data representing performance by the user and the finger position data.

16. The information processing system according to claim 15, wherein
the generation of the finger position data includes:
image analysis processing of estimating a position of each finger of a first hand of the user and a position of each finger of a second hand of the user by analyzing the performance image; and
left-right determination processing of determining that, of the first hand and the second hand, a hand with a thumb positioned on a left side of a little finger is the right hand, and a hand with a thumb positioned on a right side of a little finger is the left hand.

17. The information processing system according to claim 16, wherein
the performance analysis unit is configured:
to determine whether the musical instrument is played by the user in accordance with the performance data; and
not to generate the finger position data in a case where the musical instrument is not played.

18. The information processing system according to claim 15, wherein
the performance analysis unit is configured:
to determine whether the musical instrument is played by the user in accordance with the performance data; and
not to generate the finger position data in a case where the musical instrument is not played.

19. A non-transitory computer-readable medium storing a program that causes a computer system to function as:
a performance analysis unit configured to generate operation data representing one or more fingers, of a plurality of fingers of a left hand and a right hand of a user, that operate a musical instrument, by analyzing a performance image indicating the plurality of fingers of the user who plays the musical instrument; and
an operation control unit configured to execute first processing in a case where the operation data represents the musical instrument being operated with a finger of the left hand, and execute second processing different from the first processing in a case where the operation data represents the musical instrument being operated with a finger of the right hand.
